(19) United States
(12) Patent Application Publication
(10) Pub. No.: US 2015/0210001 A1
(43) Pub. Date: Jul. 30, 2015

(54) ARTIFICIAL NAIL PREPARATION, AND METHOD AND DEVICE FOR PRODUCING SAME

(71) Applicant: ROSS NAILS UG & CO. KG, Hude (DE)

(72) Inventor: Olaf Kruse, Hude (DE)

(21) Appl. No.: 14/419,469

(22) PCT Filed: Jul. 31, 2013
(86) PCT No.: PCT/DE2013/000419

§ 371 Date: Feb. 3, 2015

(30) Foreign Application Priority Data
Aug. 3, 2012 (DE) 10 2012 015 207.8

(51) Int. Cl. B29C 65/02; B05D 1/18; B05D 3/06; A45D 31/00

(52) U.S. Cl. CPC B29C 65/022; A45D 31/00; B05D 1/18; B05D 3/067; B29K 2067/00

(57) ABSTRACT

In an artificial nail preparation comprising at least one synthetic resin layer and a textile fabric cast into the synthetic resin layer, the thickness of the textile fabric is equal to the thickness of the synthetic resin layer. In order to produce the nail preparation the textile fabric is de-aerated by means of a liquid synthetic resin, wherein the textile fabric is immersed in the liquid synthetic resin and the immersed textile fabric is coated with a film material, thereby producing an intermediate product. Then the intermediate product is formed reproducibly, the liquid synthetic resin enclosed in the formed intermediate product is cured and the film material is separated from the cured synthetic resin, so that nail preparation blanks are obtained. A device for carrying out the method has a pultrusion machine which has two film web offtakes as well as a textile web offtake disposed between the film web offtakes. A synthetic resin immersion basin which has an outlet opening with a roller nip is formed between the film web offtakes. The film web offtakes and the textile web offtake are brought together with the roller nip to a production line which has at least one forming tool with a continuous synthetic resin curing means.

### BACKGROUND OF THE INVENTION

1. Field of the Invention

The invention relates to an artificial nail preparation comprising at least one synthetic resin layer and a textile fabric cast into the synthetic resin layer. In addition, the invention relates to a method for producing an artificial nail preparation in which at least one textile fabric is de-aerated by means of at least one synthetic resin. And finally the invention relates to a device for producing an artificial nail preparation comprising at least one pultrusion device.

2. Brief Discussion of the Related Art

Such nail preparations are used in particular for lengthening and/or reinforcing human finger and toe nails by applying a model layer plastic. The artificial nail preparations are also designated as nail tips and are known, for example, from the German Patent Specification DE 10 2008 039 109 B4, from the German Unexamined Laid-Open Patent Application DE 36 20 568 A1 or the German Utility Model Application 1 768 305. In order to be able to de-aerate a woven fabric with a synthetic resin, the German Unexamined Laid-Open Patent Application DE 36 20 568 A1 proposes to stretch the woven fabric over an open mould, close the mould and inject the synthetic resin at one point underneath the woven fabric into the mould so that a portion of the woven fabric is penetrated by the synthetic resin and is embedded in this. The U.S. Pat. No. 4,860,774 also describes a method for producing an artificial nail preparation in which a woven fibreglass fabric is sprayed with a synthetic resin suspension, dried, coated on one side with a pressure-sensitive adhesive and pressed with the coated side onto an adhesion triggering means.

Known nail preparations which are reinforced with textile fabrics have thicknesses which make the finger or toe nails lengthened with them appear unnaturally thick. In addition, the known methods of manufacture are disadvantageously complex and therefore cost-intensive.

### SUMMARY OF THE INVENTION

It is therefore the object of the invention to disclose an artificial nail preparation with which extensions produced on finger or toe nails acquire a particularly natural appearance and to disclose a method and a device with which this nail preparation can be produced particularly cost-effectively and simply.

This object is solved according to the invention by an artificial nail preparation having the features of patent claim 1, a method for producing the same having the features of patent claim 8 and a device for carrying out the method having the features of patent claim 14. Advantageous further developments of the invention are specified in the subclaims which are each related back to these patent claims.

The artificial nail preparation is characterized in that the thickness of the textile fabric is equal to the thickness of the synthetic resin layer. In this way, the textile fabric functioning as reinforcement in the synthetic resin layer is distributed uniformly in the entire layer cross-section of the synthetic resin layer so that individual fibres of the textile fabric directly touch the surfaces of the synthetic resin layer. In the region of this touching, the textile fabric has fibre backs partially exposed to the free atmosphere. According to the physical properties of the textile fabric used for the synthetic resin layer and the synthetic resin used for the synthetic resin layer, fibre backs located on the surfaces of the synthetic resin layer can however also be wetted with the synthetic resin of the synthetic resin layer. As a result of the incorporation of the textile fabric into the near-surface edge regions of the synthetic resin layer, in particular the tearing strength of the nail preparation according to the invention is advantageously increased. The increased tearing strength ultimately enables the formation of the synthetic resin layer in particularly small thicknesses so that a toe or finger nail extended with the nail preparation according to the invention comes particularly close to a natural toe or finger nail both with regard to its flexibility and also with regard to its external appearance.

According to a first further development of the artificial nail preparation, the synthetic resin layer comprises at least one polyester resin. As a result of their transparent and largely resistant properties with respect to acids and bases, polyester resins are particularly suitable for forming artificial toe and finger nails. In principle, however it is also feasible to form the synthetic resin layer with epoxy resins, acrylates or polyurethanes.

In order to be able to cure the artificial nail preparation particularly rapidly, reliably and cost-effectively in automated production processes, it is proposed that the polyester resin is a light-curing polyester resin. A suitable alternative to light-curing polyester resins are, for example, heat-curing polyester resins.

According to a next further development of the invention, the textile fabric is a woven fabric. Woven fabrics are suitable for forming particularly light and tear-resistant textiles as a result of their ordered fibre courses. At this point however the random laid nonwoven fabric should also be mentioned as a suitable alternative to the woven fabric.

In order to form particularly cost-effective and nevertheless durable nail preparations, the woven fabric preferably comprises a linen weave formed in a mesh-like manner. Furthermore, it lies within the framework of this invention to assign the physical properties of different types of woven fabric to various demand profiles which are imposed on nail preparations.

In practice, textile fabrics having a basis weight of less than 27 grams per square metre, preferably of less than 22 grams per square metre, have proved successful. To this end it is proposed that the textile fabric is composed of silk fibres. Both natural silk and also artificial silk can be used here. An alternative worth mentioning consists in forming the textile fabric from glass fibres.

The method according to the invention for producing an artificial nail preparation is characterized in that the fabric is immersed in the synthetic resin, that the immersed textile fabric is coated with at least one film material on both sides to produce an intermediate product, that the intermediate product is formed reproducibly, that the synthetic resin enclosed in the formed intermediate product is cured and that the film material is separated from the cured synthetic resin to obtain nail preparation blanks. For immersing the textile fabric in the synthetic resin, a synthetic resin basin is produced containing this through which the textile fabric is moved. Introducing the method of manufacture according to the invention, the textile fabric is flooded with the synthetic resin. In each case the textile fabric should be de-aerated completely during the immersion or flooding and, by the subsequent coating without a film material, is prepared for being removed from the immersion or flooding region as an intermediate product with a further de-aeration. For the reproducible forming of the intermediate product the film material and the textile fabric is in particular exposed to elastic deformations whereas in the liquid synthetic resin compensating flows are formed which reduce deformation stresses. With the subsequent curing of the liquid synthetic resin, the intermediate product held in shape solidifies as a whole so that the separation of the film material from the cured synthetic resin finally produces the dimensionally stable nail preparation blank. The dimensional stability of the nail preparation blanks is characterized by a high tensile strength and a high elastic modulus and is in particular achieved whereby the film material is placed directly on the immersed fabric so that the thickness of the textile fabric is equal to the thickness of the synthetic resin layer.

According to a first further development of the method according to the invention, the film material is rolled onto the immersed textile fabric. The rolling of the film material accordingly takes place at a time at which the textile fabric is immersed in the liquid synthetic resin or is flooded by this. With the immersion or flooding, the textile fabric is particularly reliably de-aerated. With the rolling a flat application of the film material onto the textile fabric is accomplished with the formation of a plurality of individual contact points.

In order to prevent atmospheric air from being able to be drawn into the de-aerated textile fabric via the film edges delimiting the film material outside the immersion or flooding region, the immersed textile fabric is sealed in the film material in an airtight manner. In principle, however the gluing-in or other type of surrounding of the textile fabric with the film material is a feasible possibility. With the airtight incorporation of the textile fabric, a storable intermediate product is produced whose further processing to form the nail preparation blanks can advantageously be accomplished with a temporal and/or local offset.

For the curing of the synthetic resin the film material is flooded with an ultraviolet radiation. For this purpose the film material is preferably a plastic film having transparent properties. A suitable alternative to this process step consists in curing the synthetic resin with thermal radiation. To this end, the film material is, for example, a composite film with an increased thermal conductivity.

According to a next further development of the invention, the intermediate product is handled exclusively on its airtight welded film material. For handling the intermediate product is, for example, carried, guided, gripped or pushed on the airtight welded film material.

According to a further development concluding the method according to the invention, the nail preparation blanks are divided into individual nail preparations. For the dividing preferably individual nail preparations are cut out or stamped out from the nail preparation blanks. Optionally the nail preparations can then be packed and distributed via the trade.

The device according the invention for producing an artificial nail preparation is characterized in that the pultrusion device has at least two film web offtakes as well as at least one textile web offtake disposed between the film web offtakes, that at least one synthetic resin immersion basin is formed between the film web offtakes, that the synthetic resin immersion basin has at least one outlet opening with a roller nip with which the film web offtakes and the textile web offtake are brought together to a production line and that the production line has at least one forming tool with a continuous synthetic resin curing means. The film web offtakes as well as the textile web offtake each have a pivot bearing arrangement for receiving a wound product. In the case of the film web offtakes, the wound product is preferably a film material wound onto rolls, spools or drums and in the case of the textile web offtake, the wound product is preferably a textile fabric wound onto rolls, spools or drums. The synthetic resin immersion basin formed between the film web offtakes is used to provide liquid synthetic resin and for immersing into the liquid synthetic resin a textile fabric which has been transported via the textile web offtake into the device according to the invention. The roller nip has the task of coating the immersed textile fabric with the film material on both sides to produce an intermediate product which is transported via the film web offtakes into the device according to the invention. Via the outlet opening the intermediate produce produced at the roller nip is pulled over the production line to a forming tool in which it is reproducibly formed and stabilized in the held form by curing the synthetic resin enclosed therein. With the pultrusion device the device according to the invention is particularly suitable for the continuous production of artificial nail preparations. The two film web offtakes here form a handling device with which the intermediate product is pulled continuously through the production line. The forming tool preferably has a continuous operating mode where a die tracking adapted to the take-off speed of the film web offtakes is preferably assigned to the dies of the forming tool. Such a die tracking is preferably produced by the formation of a circulating guide having a plurality of upper dies and a circulating guide having a plurality of lower dies. In principle, however it is also feasible to configure the forming tool in the manner of an ingot mould known from continuously operated continuous casting devices.

According to a first further development of the device according to the invention, the synthetic resin immersion basin has at least two basin boundaries formed from web sections of the film web offtakes. The immersion basin seal made at the basin boundaries is only accomplished by means of the film material transported into the film web offtakes. In this way, the film material is only contacted on one side by the synthetic resin provided in the synthetic resin immersion basin so that the roller nip formed at the outlet opening of the synthetic resin immersion basin, the forming tool and other processing stations located on the production line remain free from contamination by the liquid synthetic resin.

In order to produce an immersion basin seal formed between the film web offtakes, the synthetic resin immersion basin additionally has at least two connecting parts cooperating with the basin boundaries via sliding seals in a liquid-tight manner. Such connecting parts are preferably formed as fixed immersion basin walls on which the film material transported in the film web offtakes runs down in a liquid-tight manner.

According to a next further development of the invention, the synthetic resin immersion basin has a basin wall which is formed with one of the film web offtakes and which is inclined flat in the offtake direction. Inside the synthetic resin immersion basin the film web offtake forming the flat inclined basin wall and the textile web offtake run directly adjacent to one another so that a textile fabric transported in the textile web offtake dips at a particularly flat angle into the liquid synthetic resin provided in the synthetic resin immersion basin. The flat immersion angle advantageously prevents atmospheric air from the textile fabric being introduced into the liquid synthetic resin in the form of air inclusions.

According to a particularly advantageous further development of the invention, at least one film welding station located between the roller nip and the forming tool is assigned to the film web offtakes, which comprises at least two longitudinal welding heads each aligned onto one of the edge regions of the production line. The longitudinal welding heads are used for edge-side welding of the film material coating the textile fabric on both sides. As a result of the continuous pulling of the intermediate product through the production line, the film material transported into the film web offtakes is welded to one another by the edge-side arrangement of the longitudinal welding heads to form a film tube. In addition, the film welding station has at least one transverse welding head aligned on the production line which is used for the front-side welding of the film material coating the textile fabric on both sides. Together with the longitudinal welding heads, the transverse welding head enables completely airtight welding of the textile fabric into the film material.

For the continuous pulling of the intermediate product through the production line, the film web offtakes have at least one drive unit located upstream of the forming tool, which has at least one pair of transport rollers aligned on the production line. The transfer of the drive forces produced by the drive unit to the intermediate product is preferably accomplished by means of the adhesive friction forces which are built up between a rubber coating of the pair of transport rollers and the film material of the intermediate product.

According to a next further development of the invention, the production line comprises a de-moulding station located downstream of the moulding tool, to which at least two film web winders each operatively connected to one of the film web offtakes are assigned. The film web winders have the task of separating the film material from the cured synthetic resin in an ordered manner to obtain the nail preparation blanks. The separation is preferably accomplished by means of a take-off process by means of which the film material is guided out from the production line via deflecting rollers. In order to be able to separate the nail preparation blanks from the cured synthetic resin, the de-moulding station additionally has a cutting device with which the welds located at the edges on the intermediate product are cut away.

In order to be able to cut the nail preparation blanks into individual nail preparations, at least one cutting device is located downstream of the de-moulding station, which comprises at least one transverse cutting edge aligned on the production line. The cutting device preferably also has a continuous operating mode where a cutting tracking adapted to the offtake speed of the film web offtakes is preferably assigned to the transverse cutting edge. Such a cutting tracking is produced, for example, by incorporating the transverse cutting edge on a rotational body on the circumference of which a plurality of transverse cutting edges are preferably then held.

### BRIEF DESCRIPTION OF THE DRAWINGS

An exemplary embodiment of the invention from which further inventive features are obtained is shown in the drawing. In the figures:

FIG. 1 shows a perspective partial view of an artificial nail preparation according to the invention;

FIG. 2 shows a schematic view of a first part of the device according to the invention for producing the nail preparation according to FIG. 1; and

FIG. 3 shows a schematic view of a second part of the device according to the invention according to FIG. 2.

### DETAILED DESCRIPTION OF THE PREFERRED EMBODIMENTS

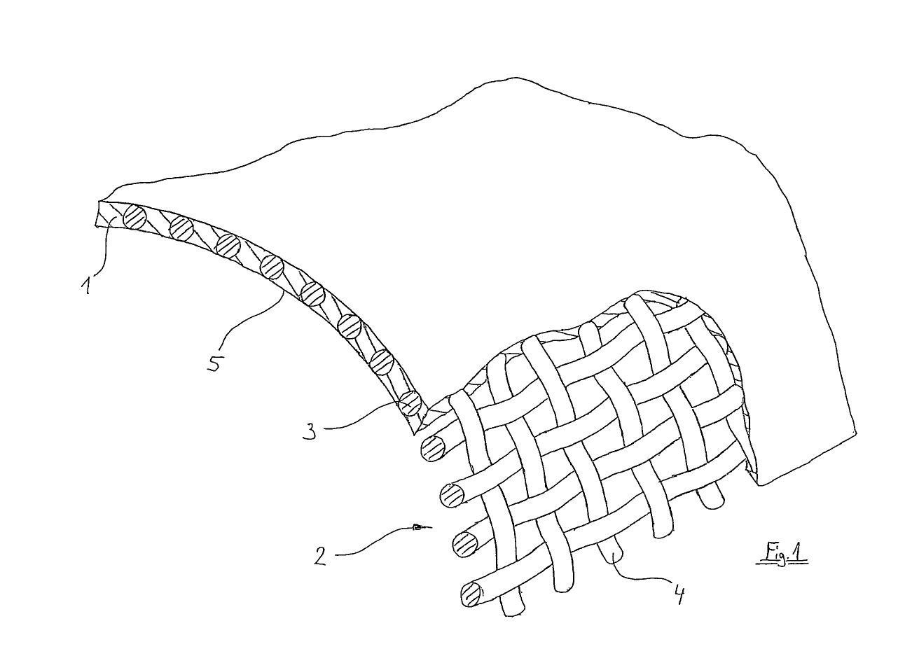

FIG. 1 shows a part of an artificial nail preparation according to the invention comprising a synthetic resin layer 1 and a textile fabric 2 cast into the synthetic resin layer 1. The thickness of the textile fabric 2 is equal to the thickness of the synthetic resin layer 1 which consists of a polyester resin. The textile fabric 2 is a woven fabric having a linen weave having a basis weight of 20 g per m². The textile fabric 2 is composed of individual silk fibres 3, 4. In particular, the artificial nail preparation has a curved contact surface 5 adapted to the nail bed of a human toe or finger nail.

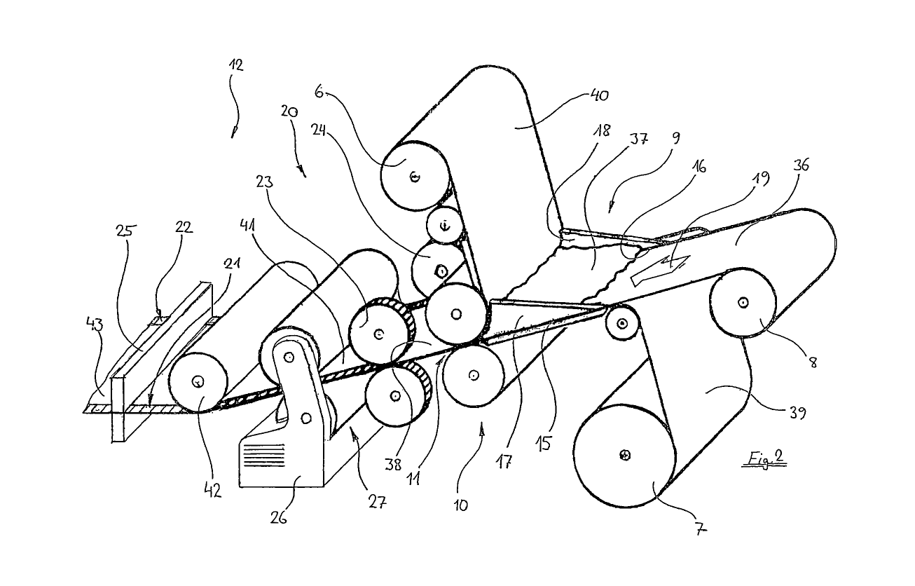

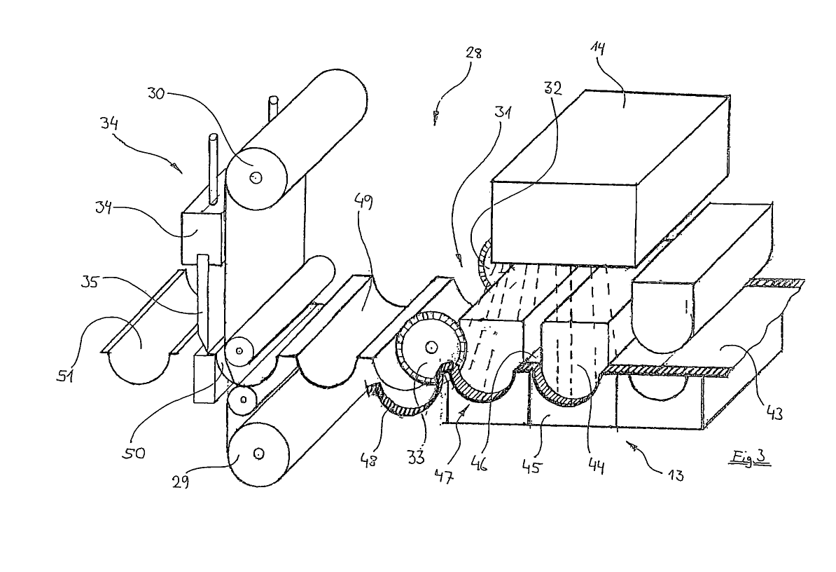

FIGS. 2 and 3 show the device according to the invention comprising a pultrusion device which has two film web offtakes 6, 7 and a textile web offtake 8 disposed between the film web offtakes 6, 7. A synthetic resin immersion basin 9 which has an outlet opening 11 formed with a roller nip 10 is formed between the film web offtakes 6, 7. Via the roller nip 10 the film web offtakes 6, 7 and the textile web offtake 8 are brought together to a production line 12, which comprises a forming tool 13 with a synthetic resin continuous curing 14. The synthetic resin immersion basin 9 has two basin boundaries formed from web sections of the film web offtakes 6, 7 and two connecting parts 17, 18 which cooperate via sliding seals 15, 16 in a liquid-tight manner with the basin boundaries. One of the basin boundaries formed with the film web offtakes 6, 7 is a basin wall configured to be flat sloping in the take-off direction according to arrow 19. A film welding station 20 disposed between the roller nip 10 and the forming tool 13 is assigned to the film web offtakes 6, 7, which comprises longitudinal welding heads 23, 24 each aligned onto one of the edge regions 21, 22 of the production line 12 and a transverse welding head 25. The film web offtakes 6, 7 have a drive unit 26 disposed between the film welding station 20 and the forming tool 13, which has a pair of transport rollers 27 aligned on the production line 12. Located downstream of the forming tool 13, the production line 12 has a de-moulding station 28 with two film web winders 29, 30 each operatively connected to one of the film web offtakes 6, 7. In addition, the de-moulding station 28 has a cutting device 31 located upstream of the film web winders 29, 30 which has two longitudinal cutting edges 32, 33 each engaged with one of the edge regions 21, 22 of the production line 12. Located downstream of the de-moulding station 28 is another cutting device 34 which has a transverse cutting edge 35 aligned on the production line 12.

The device according to the invention operates as follows: A textile fabric 36 moved in the textile web offtake 8 between the film web offtakes 6, 7 is immersed in a liquid synthetic resin 37 provided in the synthetic resin immersion basin 9. Via the roller nip 10 formed at the outlet opening 11 of the synthetic resin immersion basin 9, the immersed textile fabric 36 is coated on both sides with a film material 39, 40 to produce an intermediate product 38, which is supplied to the roller nip 10 via the film web offtakes 6, 7. Subsequently the intermediate product is supplied via the production line 12 to a film welding station 20 located downstream of the roller nip 10, the longitudinal welding heads 23, 24 whereof are used to weld the film material 39, 40 to one another at the edges to form a film tube. By means of the pair of transport rollers 27 of the drive unit 26 located downstream of the longitudinal welding heads 23, 24, the intermediate product 41 welded at the edges is pulled away via the production line 12 and guided past the transverse welding head 25 by means of a deflecting roller 42. With the transverse welding head 25 the film material 39, 40 is also welded together at the front side so that the textile fabric 36 of the intermediate product 41 which is already welded at the edges can be sealed in a completely airtight manner in its film material 39, 40. In the forming tool 13 located downstream of the film welding station 20 the intermediate product 43 which has been welded at the edges and at the front is reproducibly formed between individual upper dies 44 and lower dies 45 corresponding to these, where the liquid synthetic resin 37 enclosed in the formed intermediate product 46 is cured with UV radiation in the synthetic resin continuous curing device 14 formed on the forming tool 13. Two edge strips 48 in which the welds made with the longitudinal welding heads 23, 24 are located, are separated from the cured intermediate product 47 by means of the longitudinal cutting edges 32, 33 of the cutting device 31 located downstream of the forming tool 13 in the de-moulding station 28. By means of the film web winders 29, 30 located downstream of the cutting device 31, the film material 39, 40 of the intermediate product 49 freed from the edge strips 48 is removed from the cured synthetic resin 37 to form nail preparation blanks 50. The nail preparation blanks 50 are finally divided into individual nail preparations 51 by means of the transverse cutting edge 35 of the cutting device 34 located downstream of the de-moulding station 28.

1. An artificial nail preparation comprising at least one synthetic resin layer and a textile fabric cast into the synthetic resin layer, wherein the thickness of the textile fabric is equal to the thickness of the synthetic resin layer.

2. The artificial nail preparation according to claim 1, wherein the synthetic resin layer comprises at least one polyester resin.

3. The artificial nail preparation according to claim 2, wherein the polyester resin is a light-curing polyester resin.

4. The artificial nail preparation according to claim 1, wherein the textile fabric is a woven fabric.

5. The artificial nail preparation according to claim 4, wherein the woven fabric has a linen weave.

6. The artificial nail preparation according to claim 1, wherein the textile fabric has a basis weight of less than 27 grams per square meter.

7. The artificial nail preparation according to claim 1, wherein the textile fabric is composed of silk fibers.

8. A method for producing an artificial nail preparation in which at least one textile fabric is de-aerated by means of at least one liquid synthetic resin, wherein the textile fabric is immersed in the liquid synthetic resin, that the immersed textile fabric is coated with at least one film material on both sides to produce an intermediate product, that the intermediate product is formed reproducibly, that the liquid synthetic resin enclosed in the formed intermediate product is cured and that the film material is separated from the cured synthetic resin to obtain nail preparation blanks.

9. The method according to claim 8, wherein the film material is rolled onto the immersed textile fabric.

10. The method according to claim 9, wherein the immersed textile fabric is sealed in the film material in an airtight manner.

11. The method according to claim 8, wherein the film material is flooded with ultraviolet radiation for curing the synthetic resin.

12. The method according to claim 10, wherein the intermediate product is handled on its airtight welded film material.

13. The method according to claim 8, wherein the nail preparation blanks are divided into individual nail preparations.

14. The device for producing an artificial nail preparation comprising at least one pultrusion device, in particular for carrying out a method according to claim 8, wherein the pultrusion device has at least two film web offtakes as well as at least one textile web offtake disposed between the film web offtakes, that at least one synthetic resin immersion basin is formed between the film web offtakes, that the synthetic resin immersion basin has at least one outlet opening with a roller nip with which the film web offtakes and the textile web offtake are brought together to a production line and that the production line has at least one forming tool with a continuous synthetic resin curing means.

15. The device according to claim 14, wherein the synthetic resin immersion basin has at least two basin boundaries formed from web sections of the film web offtakes.

16. The device according to claim 15, wherein the synthetic resin immersion basin has at least two connecting parts cooperating with the basin boundaries via sliding seals in a liquid-tight manner.

17. The device according to claim 14, wherein the synthetic resin immersion basin has a basin wall which is formed with one of the film web offtakes and which is inclined flat in the offtake direction.

18. The device according to claim 14, wherein at least one film welding station located upstream of the forming tool is assigned to the film web offtakes, which comprises at least two longitudinal welding heads each aligned onto one of the edge regions of the production line.

19. The device according to claim 14, wherein the film web offtakes have at least one drive unit disposed between the film welding station and the forming tool, which has at least one pair of transport rollers aligned on the production line.

20. The device according to claim 14, wherein the production line comprises a de-moulding station located downstream of the moulding tool, to which at least two film web winders each operatively connected to one of the film web offtakes are assigned.

21. The device according to claim 20, wherein at least one cutting device is located downstream of the de-moulding station, which comprises at least one transverse cutting edge aligned on the production line.
